(19) United States
(12) Patent Application Publication
(10) Pub. No.: US 2021/0284540 A1
(43) Pub. Date: Sep. 16, 2021

(54) FACILE CO2 SEQUESTRATION AND FUEL PRODUCTION FROM A HYDROCARBON

(71) Applicant: University of Florida Research Foundation, Inc., Gainesville, FL (US)

(72) Inventors: Jonathan SCHEFFE, Gainesville, FL (US); Kent J. WARREN, Mission, TX (US)

(21) Appl. No.: 17/258,191

(22) PCT Filed: Jul. 18, 2019
(86) PCT No.: PCT/US2019/042327

§ 371 Date: Jan. 6, 2021

Related U.S. Application Data
(60) Provisional application No. 62/699,932, filed on Jul. 18, 2018.

(51) Int. Cl. C01B 32/50; C01B 5/00; C01F 17/32; B01J 19/32; B01J 19/24

(52) U.S. Cl. CPC C01B 32/50; C01B 5/00; C01F 17/32; B01J 19/32; B01J 19/2415; B01J 2219/00186; C01P 2004/03; C01P 2006/12; B01J 2219/00245; B01J 2219/00087; B01J 2219/00162; C01P 2002/72

(57) ABSTRACT

The present disclosure provide for methods of reforming a hydrocarbon such as methane. In an aspect, when the method is driven via renewable energy (e.g., use of solar energy, wind energy, or other renewable energy) and coupled with zero-energy input product gas separation, this enables the capture of pure CO₂ (i.e., carbon sequestration) and carbon-neutral utilization of methane can be achieved. As a result, the present disclosure can provide for a method to reform methane with zero-energy input product gas separation.

### CROSS-REFERENCE TO RELATED APPLICATIONS

This application claims the benefit of and priority to U.S. Provisional Application Ser. No. 62/699,932, having the title “FACILE CO2 SEQUESTRATION AND FUEL PRODUCTION FROM METHANE”, filed on Jul. 18, 2018, the disclosure of which is incorporated herein by reference in its entirety.

### BACKGROUND

Chemical-looping reforming (CLR) is a Gas-to-Liquids (GTL) technology that leverages the redox behavior of metal oxides to facilitate syngas (a mixture of H₂ and CO) production from methane.[1-3] As shown in FIG. 1A, CLR is operated cyclically and composed of: (1) endothermic reduction of a metal oxide via methane partial oxidation in the absence of gas-phase oxygen and (2) exothermic oxidation of the reduced metal oxide via H₂O and/or CO₂ dissociation. Contrary to conventional steam and dry reforming of methane (SMR and DMR, respectively), performing oxidation with H₂O and/or CO₂ in CLR permits a wide range of attainable syngas ratios (H₂/CO=3:1) while oxidizing solid carbon that may deposit during methane delivery. When coupled with well-documented catalytic pathways like Fischer-Tropsch (FT) synthesis, syngas produced through CLR can be converted to a variety of long-chain hydrocarbon fuels (e.g., diesel and jet fuel) at a higher quality than if derived through refining crude oil.[4] However, like conventional reforming pathways, depending on the operating temperature and pressure, the effluent of step (1) may contain undesired products such as CH₄, H₂O, and CO₂. As a result, at the expense of lower process efficiency, energy-intensive gas-separation equipment, such as water gas shift reactors, pressure swing absorbers and/or polymer-based membranes,[5, 6] is required to yield an acceptable syngas ratio for FT synthesis.

### SUMMARY

Embodiments of the present disclosure provide for methods of reforming a hydrocarbon such as methane. In an aspect, when the method is driven via renewable energy (e.g., use of solar energy, wind energy, or other renewable energy) and coupled with zero-energy input product gas separation, this enables the capture of pure CO₂ (i.e., carbon sequestration) and carbon-neutral utilization of methane can be achieved.

In an aspect, the present disclosure provides for a method of reforming a hydrocarbon, comprising: exposing the hydrocarbon to an oxide, and forming, primarily, H₂O and CO₂ or H₂O and C as opposed to the formation of H₂ and CO. The hydrocarbon can be methane. The operating condition can comprise operation at a temperature of less than 1000° C. The exposing can be conducted for a time frame to form H₂O and either CO₂ or C over H₂ and CO. The oxide is selected from an oxide having the characteristic of forming H₂O and either CO₂ or C over H₂ and CO. The oxide can be selected from: an oxide of zinc, tin, iron, cobalt, copper, alumina, cerium, and mixtures thereof, wherein the oxide is optionally doped with one or more of: strontium, lithium, gadolinium, samarium, praseodymium, zirconia, or hafnium.

In another aspect, the present disclosure provides a system for reforming a hydrocarbon, comprising: a reforming reactor, wherein the reforming reactor is configured to operate at operating conditions to form, primarily, H₂O and CO₂ or H₂O and C as opposed to the formation of H₂ and CO; and a parabolic trough, wherein the parabolic trough is in electrical or thermal communication with the reforming reactor, wherein the energy derived from the parabolic trough is used to adjust the operating conditions in the reforming reactor.

### BRIEF DESCRIPTION OF THE DRAWINGS

Further aspects of the present disclosure will be more readily appreciated upon review of the detailed description of its various embodiments, described below, when taken in conjunction with the accompanying drawings.

FIGS. 1A-1D provide a compilation of common chemical-looping techniques that leverage the oxygen-exchange capacity of metal oxides, denoted as MₓO_{y}. FIG. 1A shows chemical-looping reforming, CLR. FIG. 1B shows chemical-looping combustion, CLC. FIG. 1C shows three-reactor chemical-looping hydrogen generation, TRCL. FIG. 1D shows two-reactor chemical-looping hydrogen generation, CLH. CO₂ can replace H₂O as the steam reactor oxidant to generate pure streams of CO.

FIGS. 2A-2B show equilibrium product distribution (bisected into FIGS. 2A and 2B for clarity) and corresponding oxygen nonstoichiometry (FIG. 2C) of methane-driven reduction of ceria-zirconia solid solutions plotted as a function of temperature. n_{i,CH4}=0.15 mol_{CH4} mol_{CeO2-Zr}⁻¹ and pₜₒₜ=1 bar in accordance with embodiments of the present disclosure.

FIGS. 3A-3B show equilibrium product distribution and corresponding oxygen nonstoichiometry of methane-driven reduction of Ce_{0.80}Zr_{0.20}O₂ at T=500° C. plotted as a function of (FIG. 3A) CH₄/O₂ ratio (pₜₒₜ=1 bar) and (FIG. 3B) pₜₒₜ (n_{i,CH4}=0.05 mol_{CH4} mol_{CeO2-Zr}⁻¹) in accordance with embodiments of the present disclosure.

FIGS. 4A-4B illustrate cumulative (FIG. 4A) syngas and (FIG. 4B) non-syngas production during reduction of ceria via the partial oxidation of methane at three discrete tube temperatures in accordance with embodiments of the present disclosure.

FIG. 5 provides an example of an equilibrium product distribution and corresponding oxygen nonstoichiometry of ceria reduction via syngas (Hz/CO) oxidation plotted as a function of temperature. n_{i,CH2}=0.10 mol_{H2} mol_{CeO2}⁻¹, n_{i,CO}=0.05 mol_{CO} mol_{CeO2}⁻¹, and pₜₒₜ=1 bar.

FIG. 6 provides powder X-ray diffraction (PXRD) data of the Ce_{0.9}Zr_{0.1}O₂ sample that was derived via a modified Pechini method, according to embodiments of the present disclosure.

FIG. 7A provides an example of transient outlet specific molar flow rates of a representative methane-driven reduction of Ce_{0.9}Zr_{0.1}O₂ and CeO₂ at T_{ref}=750° C. FIG. 7B provides an example of collocated reduction nonstoichiometry of each sample obtained at different T_{ref}. FIG. 7C provides an example of H₂O and CO₂ selectivity for each sample, evaluated at constant composition (δ_{red}=0.01) and different T_{ref}. Equivalent operating conditions include: m_{s,i}=25 mg, pCH₄=0.03 atm, and tₒₓ=2 min. In each subplot, solid and dashed lines refer to Ce_{0.9}Zr_{0.1}O₂ and CeO₂, respectively.

FIG. 8 is a schematic according to embodiments of the present disclosure, e.g., using the redox behavior of ceria-zirconia-based solid solutions to completely oxidize methane and subsequently generate hydrogen (and/or carbon monoxide). The thermodynamics of these reactions enable facile gas separation via condensation and the use of lower-cost solar concentrating systems, such as parabolic troughs, to provide the necessary process heat.

The drawings illustrate only example embodiments and are therefore not to be considered limiting of the scope described herein, as other equally effective embodiments are within the scope and spirit of this disclosure. The elements and features shown in the drawings are not necessarily drawn to scale, emphasis instead being placed upon clearly illustrating the principles of the embodiments. Additionally, certain dimensions may be exaggerated to help visually convey certain principles. In the drawings, similar reference numerals between figures designate like or corresponding, but not necessarily the same, elements.

### DETAILED DESCRIPTION

Before the present disclosure is described in greater detail, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, inorganic chemistry, material science, and the like, which are within the skill of the art. Such techniques are explained fully in the literature.

The following examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is in atmosphere. Standard temperature and pressure are defined as 25° C. and 1 atmosphere.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

### Discussion

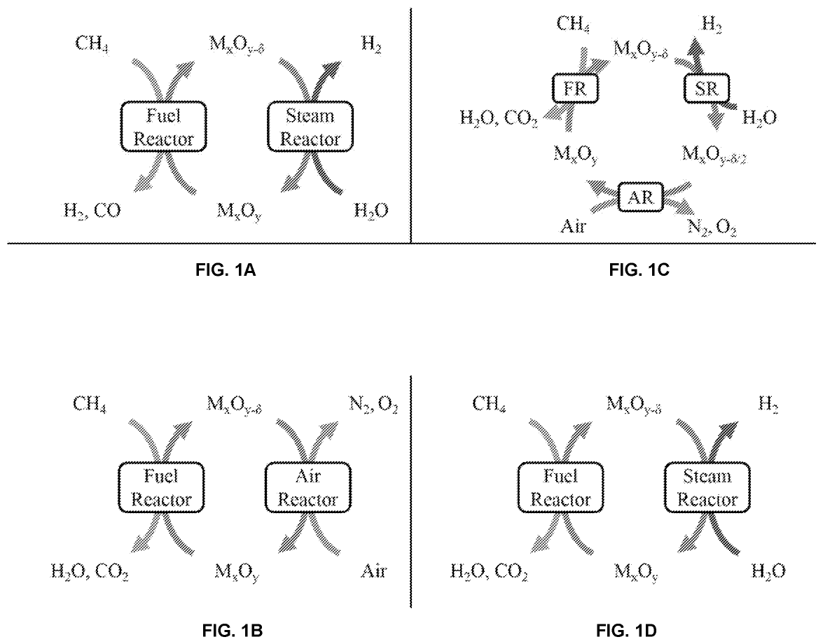

Chemical-looping combustion (CLC) is a related redox technique that considers complete hydrocarbon oxidation in the first step (i.e. H₂O and CO₂ production rather than synthesis gas) to ensure efficient and low-cost CO₂ capture via H₂O condensation.[5] Since the primary objective of conventional CLC is to sequester CO₂ from fossil-fuel combustion effluents, reduced metal-oxide regeneration is generally initiated with air (see FIG. 1B). Chiesa et al., using iron oxide, proposed a modification to the standard CLC concept by introducing an intermediate H₂O dissociation step to simultaneously generate H₂ and partially oxidize the reduced iron oxide.[7] However, as shown in FIG. 1C, subsequent oxidation in air was still required for complete metal-oxide regeneration, a consequence of unfavorable oxidative thermodynamics. Commonly known as three-reactor chemical-looping (TRCL) or chemical-looping hydrogen (CLH) generation, individual streams of pure CO₂ and H₂ (or CO if CO₂ is the delivered oxidant) could be produced without intensive gas separation processes required of other reforming technologies like SMR, DMR or CLR.[8-12] Further, the addition of a second air-fed oxidation step has been shown to make the overall process net exothermic and thus, in theory, could be operated as an autothermal process without an external energy source. [13]

Simplified CLH processes using iron oxides have been proposed where oxidation is performed solely via H₂O/CO₂ splitting, thus lowering the complexity of the aforementioned three-reactor concept to two; a schematic can be seen in FIG. 1D. However, successful operation is infeasible because, unlike air or O₂, H₂O/CO₂ does not have sufficient oxygen activity to completely oxidize FeO or Fe₃O₄ to Fe₂O₃. This results in incomplete methane oxidation during the subsequent reduction reaction, leading to syngas production and eliminating the possibility of facile gas separation.[14-16] In addition to unfavorable oxidation thermodynamics, iron oxide is known to form layered scales at the particle substrate, hindering morphological stability and oxidation kinetics.[17] Other studies, although motivated by two-step CLH, actually investigate a derivative of the steam-iron process[18] by oxidizing syngas as a surrogate for alkanes that would be oxidized in practice.[19, 20].

Embodiments of the present disclosure provide for methods of reforming a hydrocarbon (e.g., C1 to C5 hydrocarbon, in particular methane). Although portions of the discussion are directed to methane, the methods and systems can be used for other hydrocarbons as well.

In an aspect, when the method is driven via renewable energy (e.g., use of solar energy, wind energy, or other renewable energy) and coupled with zero-energy input product gas separation, this enables the capture of pure CO₂ (i.e., carbon sequestration) and carbon-neutral utilization of methane can be achieved. As a result, embodiments of the present disclosure provide for a method to reform methane with zero-energy input product gas separation.

Chemical-looping reforming processes involve a reaction of methane with a metal-oxide at high temperatures (T>700° C.) to produce H₂ and CO, thereby reducing the oxide; H₂O and CO₂ are considered undesirable and efforts are made to drive the reaction to form H₂ and CO. In a second step, the reduced oxide may be exposed to H₂O, CO₂, or a combination thereof to produce additional H₂ and/or CO and re-oxidize the oxide to its initial state. H₂ and the combination of H₂/CO may be considered as fuel or fuel precursors, respectively.

In contrast, aspects of the present disclosure alter the first redox reaction such that it is selective (e.g., primarily form) to H₂O and either CO₂ or C formation, rather than H₂ and CO (see equation 1 below). As a result, this approach is against the trends of methane reforming. The method can include one or more of the following strategies: use appropriate oxides, increase the oxide surface area, select or tune the oxide's thermodynamic properties through doping or catalytic enhancement, change the operating temperature (e.g., decrease) and/or pressure, or alter the reaction time. By forcing the reaction to produce H₂O rather than H₂, this enables passive gas separation via condensation processes if either or CO₂ gas or solid C is produced rather than CO.

Embodiments of the present disclosure represent a significant advancement over state of the art methane reforming. In typical reforming, in order to produce carbon-neutral fuels from methane via reforming, several additional energetic steps are required. These are step 1) purification of oxygen (if methane partial oxidation is employed), step 2) shifting reaction from CO to CO₂ and step 3) subsequent gas separation of H₂ and CO₂. In aspects of the present disclosure, only the separation of H₂O from CO₂ or H₂O from C are necessary, both of which are energetically benign and may be accomplished through condensation of the H₂O.

An aspect of the present disclosure is directed to a two-step method for facile CO₂ sequestration from methane with subsequent Hz/CO production by leveraging the oxygen-exchange capacity of an oxide such as ceria or ceria-based oxides. For example, a reaction scheme is shown below for ceria, but other oxides or catalytically enhanced oxides would function in a similar manner.

### Endothermic Reduction in CH4

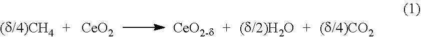

### Exothermic Oxidation in H₂O:

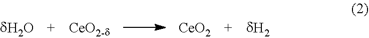

### Exothermic Oxidation in CO₂:

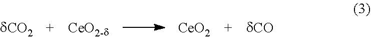

Here, δ refers to the degree of oxygen nonstoichiometry. In an aspect, the catalyst used in the present disclosure (e.g., ceria) offers several advantages when compared to iron-oxide. For example, equilibrium thermodynamic calculations of ceria oxidation (eqs. 2 and 3) predict near-complete conversion (i.e., CeO₂) with either H₂O/CO₂ or air/O₂,[21] and inherently fast rates of oxygen-ion diffusion [22] contribute to rapid redox kinetics.[23] These advantages have motivated several research endeavors that investigate the use of ceria-based materials in CLR pathways [3, 24, 25], but to date, ceria or ceria-based materials have not been proposed for use in CLH. Since the oxidation of ceria (eqs. 2 and 3) is well documented in literature,[26] this disclosure proposes different approaches to ensure complete selectivity to H₂O and CO₂ (reaction 1) rather than H₂ and CO, as is typical for CLR.

When compared to CLR, selective conversion of methane to H₂O and CO₂ (eq. 1) does not lessen the quantity of produced fuel per mole of consumed methane. Since more oxygen is removed from ceria (i.e., production of H₂O and CO₂ vs. H₂ and CO), more fuel will simply be produced during subsequent oxidation (eqs. 2 and 3).

In an aspect, the selective conversion of methane to H₂O or CO₂ over an oxide (e.g., ceria-based materials) enables facile CO₂ sequestration and subsequent H₂ and/or CO generation and can be accomplished using one or multiple strategies described herein. These strategies can be used individually or in any combination in the two-step CLH process (see FIG. 1D).

In an aspect, the method of reforming methane can include exposing a hydrocarbon such as methane to an oxide and primarily forming (e.g., about 95% or more, about 97% or more, about 98% or more, or about 99% or more) H₂O and CO₂ or H₂O and C as opposed to the formation of H₂ and CO (e.g., forming about less than 5% H₂ and CO, forming about less than 3% H₂ and CO, forming about less than 2% H₂ and CO, or forming about less than 1% H₂ and CO). Exposing the methane to the oxide can occur in a reforming reactor such as those known in the art (e.g., packed-bed, fluidized-bed, downer, and aerosol). In other words, much less or close to zero H₂O and C are produced, albeit in many instances at least a small amount of H₂ and CO can be produced. The operating conditions are selected to form H₂O and CO₂ or H₂O and C as opposed to the formation of H₂ and CO. In an aspect, the operating conditions can include operating at a temperature of about 1000° C. or less, about 800° C. or less, about 775° C. or less, about 750° C. or less, about 700° C. or less, about 600° C. or less, about 550° C. or less, or about 500° C. In an aspect, the operating pressure can be greater or less than that used in standard methane reforming (e.g., 0.01 atm or 5 atm, or about 1 to 3 atm, or about 1 atm). The methane can be exposed to the oxide for a residence time that reduces or eliminates the formation of H₂ and CO and maximizes the formation of H₂O and either CO₂ or C. The time frame for the reaction can be about 1 second to 1 hour or about 1 minute to 10 minutes.

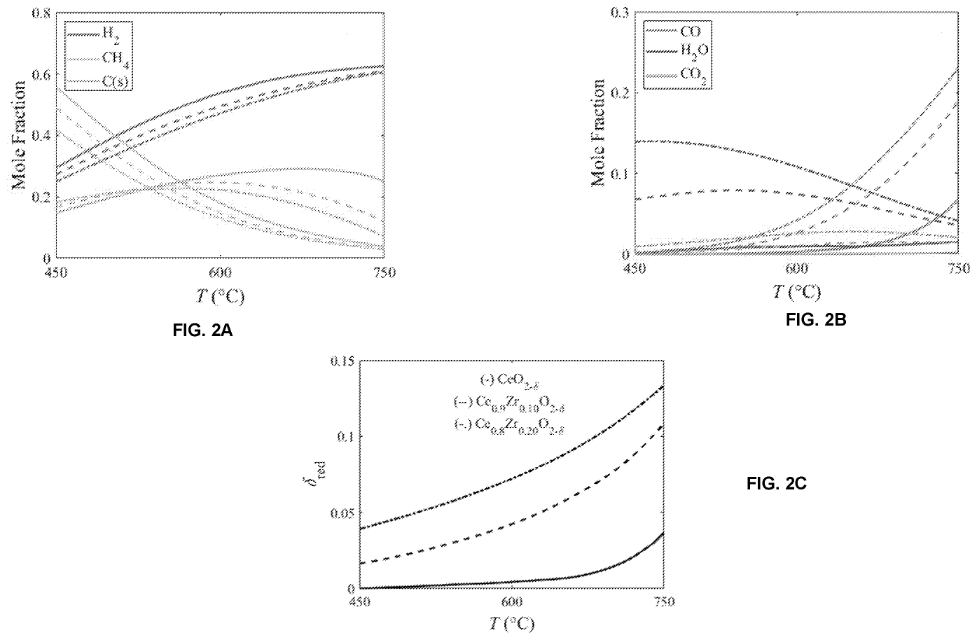

In another aspect, the oxide will be more selective (e.g., primarily form) for H₂O and/or CO₂. In an aspect, the oxide can be an oxide of zinc, tin, iron, cobalt, copper, alumina, cerium, and mixtures thereof. In addition, the oxide can be doped with dopants such as strontium, lithium, gadolinium, samarium, praseodymium, zirconia, hafnium, and the like. In an aspect, the oxide can include Zr⁴⁺ doped ceria, Hf⁴⁺ doped ceria, other single and multi-doped ceria variants such as but not limited to Sc²⁺, Ca²⁺, Gd³⁺, Sm³⁺, and Mn-based perovskites (e.g. the exact formulation can be stoichiometrically determined for the doping). Inclusion of dopants can modify the thermodynamic properties (e.g., decreasing the partial molar enthalpy) of the oxide, such that reaction 1 is more selective to H₂O and/or CO₂ formation (See Example, FIGS. 2A, 2B and 2C). The oxide can also be catalytically enhanced with metal additives, such as nickel, platinum, palladium, gold, silver, and the like. In an aspect, metal additives can aid in improving reaction rates at lower operating temperatures as well as selectivity for H₂O and/or CO₂. Furthermore, the oxide can be designed or prepared to have a large surface area (e.g., greater than 4 m² g⁻¹). Increasing the surface area of ceria has also been shown to increase reaction 1 selectivity, as the surface is more easily reduced than the bulk.[3]

In an aspect, the present disclosure provides for a method to reform methane with zero-energy input product gas separation, where the reforming reactor is in electrical or thermal communication with a renewable energy source system such as solar energy (e.g., a parabolic trough), wind energy, or other renewable energy. The system can separate product gas from the reaction enabling the capture of pure CO₂ (i.e., carbon sequestration) and enforce carbon-neutral utilization of methane.

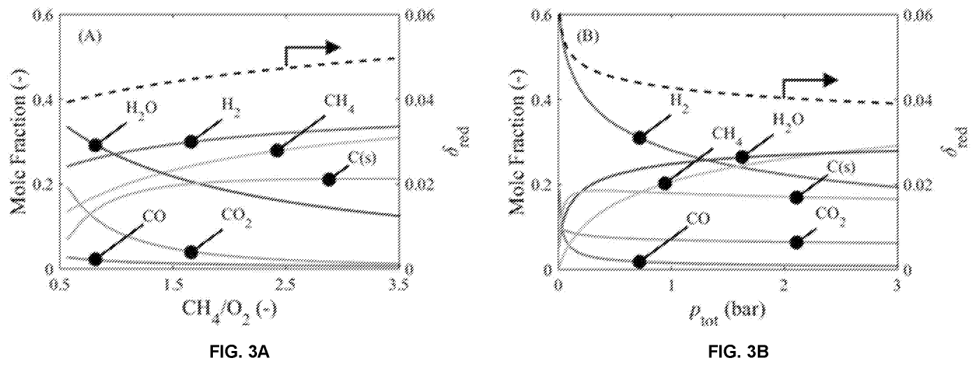

In an aspect, the operating conditions can be tuned so the formation of H₂O, CO₂ is thermodynamically more favorable than H₂/CO, which as described herein is counter to other processes. Prior equilibrium thermodynamic analyses motivated by CLR over ceria indicate that the formation of H₂O, CO₂, CH₄, and C is favorable at low temperatures (T<600° C.),[27, 28] below where conventional reforming processes typically occur (See Examples, FIGS. 2A, 2B and 2C). In addition, carbon deposition may be avoided and H₂O/CO₂ selectivity enhanced by lessening the amount of delivered CH₄, thereby limiting the reaction extent, 5 (See Examples, FIG. 3A).[29-31] Additional increases to H₂O and CO₂ selectivity are attainable by increasing the system pressure (e.g., 1 atm to 3 atm) (See Examples, FIG. 3B). Low-temperature operation will enable use of comparatively-inexpensive construction materials (as compared to other processes that require higher temperature). The use of lower temperatures and/or pressure can be useful for systems that incorporate use of solar energy, such as parabolic trough systems that are not typically capable of achieving temperatures required to drive conventional reforming reactions.

In embodiments where carbon deposition is unavoidable, the carbon can be sufficiently combusted in the oxidation step (eqs. 2 and 3) to produce CO via the reaction with H₂O or CO₂ (Boudouard reaction).[28] In this scenario, the output of oxidation will either be pure streams of CO or syngas that can be subjected to FT synthesis.

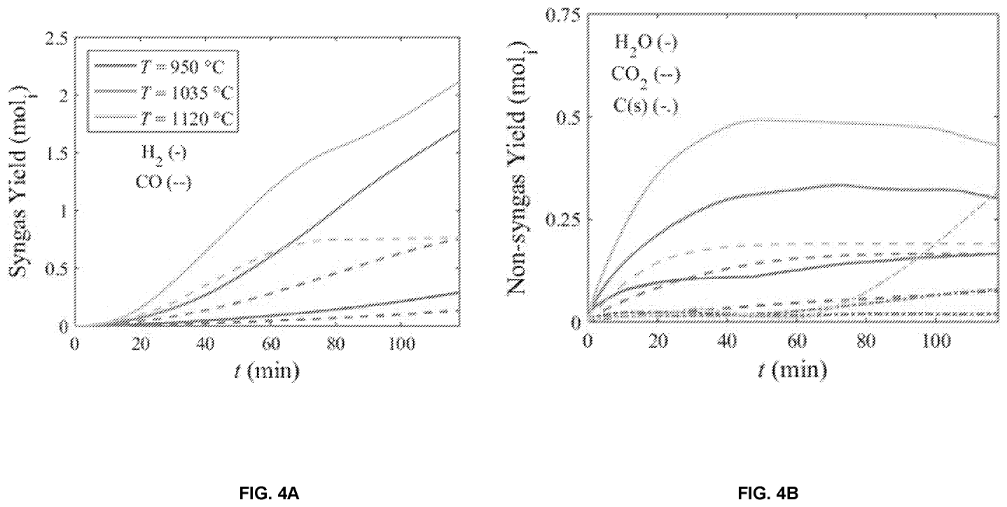

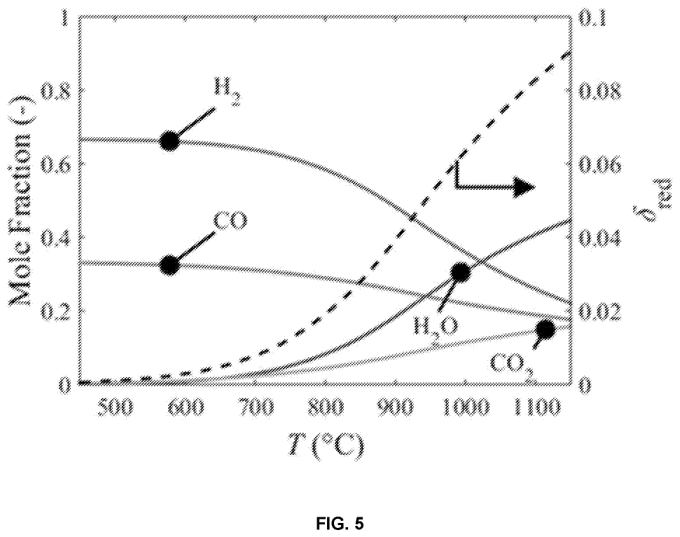

In another embodiment, the exposure time of undesired reforming products (H₂ and CO) to unreacted catalyst is controlled to reduce the H₂ and CO formed and maximize H₂O and/or CO₂ the formed. In a study, CLR over ceria was experimentally evaluated in a prototype reactor, and initial H₂O and CO₂ yields were attributed to the packed-bed design.[28] In such configuration, produced syngas near the entrance of the bed was sufficiently oxidized by unreacted ceria near the bed and gas outlet (See Appendix, FIGS. 4A-4B and 5).

Advantages of aspects of the present disclosure include that this novel process has no effect on the fuel yield per mole of consumed methane. For embodiments that use a renewable energy source, carbon-neutral utilization of methane and zero-energy input product gas separation coupled with CO₂ capture can be achieved when the endothermic reforming reaction (1) is driven to produce either H₂O and CO2 or C.

### EXAMPLES

### Example 1

To elucidate using ceria dopants or other oxides as a strategy to selectively produce H₂O and CO₂ during the reforming reaction, a closed-system thermodynamic model was used to investigate the effect of Zr⁴⁺ doping of CeO₂. Model formulation and accompanying assumptions are thoroughly discussed in a prior analysis of methane-driven ceria reduction.[28] Here, thermodynamic properties (i.e., partial molar enthalpy and entropy) of Ce₁₋ₓZrₓO_{2-δ} (x≤0.20) were obtained from previously reported experimental data.[35] FIGS. 2A-C display the equilibrium product distribution and corresponding oxygen nonstoichiometry for pure and Zr-doped ceria at n_{i,CH4}=0.15 mol_{CH4} mol_{CeO2-Zr}⁻¹ and 1 bar. Fora given temperature, the equilibrium oxygen nonstoichiometry bred (FIG. 2C) increases with zirconium content. As a result, CH₄ conversion and selectivity of oxygen-containing products (i.e., CO, H₂O, and CO₂) also increase, while lowering the amount of H₂ and C(s) expected at equilibrium. Furthermore, as temperature decreases, the favorability of H₂O and CO₂ formation increases at the expense of a reduced CH₄ conversion and oxygen nonstoichiometry.

In addition to lowering the reaction temperature, the selectivity towards H₂O and CO₂ can be further tuned with changes to other operating conditions. For methane-driven reduction of Ce_{0.80}Zr_{0.20}O₂ at 500° C. and 1 bar, the impact of varying the reaction extent on the equilibrium distribution is shown in FIG. 3A. As the reaction extent and thus CH₄/O₂ ratio (i.e., n_{i,CH4}/δ_{red}) decreases, equilibrium CH₄ conversion and formation of CO, H₂O, and CO₂ increase, while H₂ and C(s) decrease. Increasing the system pressure pₜₒₜ can further decrease the amount of syngas (H₂ and CO) expected at equilibrium, as shown in FIG. 3B for Ce_{0.80}Zr_{0.20}O₂ at 500° C. and n_{i,CH4}=0.05 mol_{CH4} mol_{CeO2-Zr}⁻¹. Therefore, at the expense of a reduced CH₄ conversion and oxygen nonstoichiometry, the selectivity of H₂O and CO₂ increases.

In a prior study,[28] CLR over ceria (see FIG. 1A) was experimentally evaluated in an indirectly irradiated, packed-bed tubular reactor, where thermal radiation was supplied via a high-flux solar simulator. The cumulative syngas and non-syngas yields during reduction at isothermal temperatures of 950° C., 1035° C., and 1120° C. are displayed in FIGS. 4A and 4B, respectively. In agreement with equilibrium thermodynamic predictions (see FIGS. 2A-2C), syngas production increased with increasing tube temperature. However, at the beginning of each reduction reaction, the product distributions were generally characterized by the formation of H₂O and CO₂, as also observed in lab-scale experimental demonstrations.[30, 31, 36] A consequence of the packed-bed reactor design, syngas formed via methane partial oxidation at initial times was oxidized to form H₂O and CO₂ as it encountered unreacted ceria in the remainder of the packed bed. Thus, optimizing the exposure time of undesired reforming products (i.e., CH₄, H₂, and CO) to an unreacted metal oxide can enforce high H₂O and CO₂ selectivity during reduction. It is important to note, coking was only significantly observed at 1120° C. after the packed bed of ceria had exhausted its capability to release lattice oxygen (t>75 min) and is attributed to a side-reaction with the Al₂O₃ tube.[37]

To support the aforementioned experimental observation, a closed-system thermodynamic model was used to investigate the reduction of ceria via syngas oxidation. FIG. 5 displays the equilibrium product distribution and corresponding oxygen nonstoichiometry for pure ceria at n_{i,H2}=0.10 mol_{H2} mol_{CeO2}⁻¹, n_{i,CO}=0.05 mol_{CO} mol_{CeO2}⁻¹, and 1 bar. As temperature increases, gaseous oxygen evolution, and thus H₂O and CO₂ selectivity, increases. Further syngas conversion can be achieved by tuning the reaction extent and system pressure, as can be seen in FIGS. 3A-3B for ceria reduction via methane oxidation.

### References for Example 1

[1] L. Protasova, F. Snijkers, Recent developments in oxygen carrier materials for hydrogen production via chemical looping processes, Fuel, 181 (2016) 75-93.
[2] G. Voitic, V. Hacker, Recent advancements in chemical looping water splitting for the production of hydrogen, RSC Advances, 6 (2016) 98267-98296.
[3] P. T. Krenzke, J. R. Fosheim, J. H. Davidson, Solar fuels via chemical-looping reforming, Solar Energy, (2017).
[4] M. E. Dry, The fischer-tropsch process: 1950-2000, Catalysis today, 71 (2002) 227-241.
[5] M. M. Hossain, H. I. de Lasa, Chemical-looping combustion (CLC) for inherent CO2 separations—a review, Chemical Engineering Science, 63 (2008) 4433-4451.
[6] J. D. Figueroa, T. Fout, S. Plasynski, H. Mcllvried, R. D. Srivastava, Advances in CO2 capture technology—the US Department of Energy's Carbon Sequestration Program, International journal of greenhouse gas control, 2 (2008) 9-20.
[7] P. Chiesa, G. Lozza, A. Malandrino, M. Romano, V. Piccolo, Three-reactors chemical looping process for hydrogen production, International journal of hydrogen energy, 33 (2008) 2233-2245.
[8] H. Fang, L. Haibin, Z. Zengli, Advancements in development of chemical-looping combustion: a review, International Journal of Chemical Engineering, 2009 (2009).
[9] W. C. Cho, M. W. Seo, S. D. Kim, K. S. Kang, K. K. Bae, C. H. Kim, S. U. Jeong, C. S. Park, Reactivity of iron oxide as an oxygen carrier for chemical-looping hydrogen production, International journal of hydrogen energy, 37 (2012) 16852-16863.
[10] W. C. Cho, M. W. Seo, S. D. Kim, K. Kang, K. K. Bae, C. H. Kim, S. Jeong, C. S. Park, Continuous operation characteristics of chemical looping hydrogen production system, Applied Energy, 113 (2014) 1667-1674.
[11] H. Liang, Study on the effect of CeO2 on Fe2O3/LaNiO3 as the oxygen carrier applied in chemical-looping hydrogen generation, International Journal of Hydrogen Energy, 40 (2015) 13338-13343.
[12] D. Sanfilippo, One-step hydrogen through water splitting with intrinsic CO2 capture in chemical looping, Catalysis Today, 272 (2016) 58-68.
[13] S. Bhaysar, M. Najera, G. Veser, Chemical looping dry reforming as novel, intensified process for CO2 activation, Chemical Engineering & Technology, 35 (2012) 1281-1290.
[14] S. Takenaka, N. Hanaizumi, K. Otsuka, Production of pure hydrogen from methane mediated by the redox of Ni- and Cr-added iron oxides, Journal of Catalysis, 228 (2004) 405-416.
[15] S. Takenaka, V. T. Dinh Son, K. Otsuka, Storage and supply of pure hydrogen from methane mediated by modified iron oxides, Energy & fuels, 18 (2004) 820-829.
[16] M. Najera, R. Solunke, T. Gardner, G. Veser, Carbon capture and utilization via chemical looping dry reforming, Chemical Engineering Research and Design, 89 (2011) 1533-1543.
[17] G. J. Yurek, J. P. Hirth, R. A. Rapp, The formation of two-phase layered scales on pure metals, Oxidation of Metals, 8 (1974) 265-281.
[18] V. Hacker, R. Fankhauser, G. Faleschini, H. Fuchs, K. Friedrich, M. Muhr, K. Kordesch, Hydrogen production by steam-iron process, Journal of Power Sources, 86 (2000) 531-535.
[19] S. R. Son, K. S. Go, S. D. Kim, Thermogravimetric analysis of copper oxide for chemical-looping hydrogen generation, Industrial & engineering chemistry research, 48 (2008) 380-387.
[20] N. L. Galinsky, Y. Huang, A. Shafiefarhood, F. Li, Iron oxide with facilitated 02-transport for facile fuel oxidation and CO2 capture in a chemical looping scheme, ACS Sustainable Chemistry & Engineering, 1 (2013) 364-373.
[21] J. R. Scheffe, A. Steinfeld, Thermodynamic analysis of cerium-based oxides for solar thermochemical fuel production, Energy & fuels, 26 (2012) 1928-1936.
[22] N. Skorodumova, S. Simak, B. I. Lundqvist, I. Abrikosov, B. Johansson, Quantum origin of the oxygen storage capability of ceria, Physical Review Letters, 89 (2002) 166601.
[23] J. R. Scheffe, A. Steinfeld, Oxygen exchange materials for solar thermochemical splitting of H2O2O and CO2: a review, Materials Today, 17 (2014) 341-348.
[24] A. Lofberg, J. Guerrero-Caballero, T. Kane, A. Rubbens, L. Jalowiecki-Duhamel, Ni/CeO2 based catalysts as oxygen vectors for the chemical looping dry reforming of methane for syngas production, Applied Catalysis B: Environmental, 212 (2017) 159-174.
[25] M. Welte, K. Warren, J. R. Scheffe, A. Steinfeld, Combined ceria reduction and methane reforming in a solar-driven particle-transport reactor, Industrial & engineering chemistry research, 56 (2017) 10300-10308.
[26] W. C. Chueh, S. M. Haile, A thermochemical study of ceria: exploiting an old material for new modes of energy conversion and CO2 mitigation, Philosophical Transactions of the Royal Society of London A: Mathematical, Physical and Engineering Sciences, 368 (2010) 3269-3294.
[27] P. T. Krenzke, J. H. Davidson, Thermodynamic analysis of syngas production via the solar thermochemical cerium oxide redox cycle with methane-driven reduction, Energy & Fuels, 28 (2014) 4088-4095.
[28] K. J. Warren, J. Reim, K. Randhir, B. Greek, R. Carrillo, D. W. Hahn, J. R. Scheffe, Theoretical and Experimental Investigation of Solar Methane Reforming through the Nonstoichiometric Ceria Redox Cycle, Energy Technology, (2017).
[29] K. Otsuka, T. Ushiyama, I. Yamanaka, Partial oxidation of methane using the redox of cerium oxide, Chemistry letters, 22 (1993) 1517-1520.
[30] K. Otsuka, E. Sunada, T. Ushiyama, I. Yamanaka, The production of synthesis gas by the redox of cerium oxide, Studies in Surface Science and Catalysis, 107 (1997) 531-536.
[31] K. Otsuka, Y. Wang, E. Sunada, I. Yamanaka, Direct partial oxidation of methane to synthesis gas by cerium oxide, Journal of Catalysis, 175 (1998) 152-160.
[32] K. Otsuka, Y. Wang, M. Nakamura, Direct conversion of methane to synthesis gas through gas-solid reaction using CeO2-ZrO 2 solid solution at moderate temperature, Applied Catalysis A: General, 183 (1999) 317-324.
[33] P. Pantu, K. Kim, G. R. Gavalas, Methane partial oxidation on Pt/CeO2-ZrO 2 in the absence of gaseous oxygen, Applied Catalysis A: General, 193 (2000) 203-214.
[34] M. Kuhn, S. Bishop, J. Rupp, H. Tuller, Structural characterization and oxygen nonstoichiometry of ceria-zirconia (Ce1-xZrxO2-6) solid solutions, Acta Materialia, 61 (2013) 4277-4288.
[35] Y. Hao, C.-K. Yang, S. M. Haile, Ceria-Zirconia Solid Solutions (Ce1-xZrxO2-δ, x≤0.2) for Solar Thermochemical Water Splitting: A Thermodynamic Study, Chemistry of Materials, 26 (2014) 6073-6082.
[36] P. T. Krenzke, J. R. Fosheim, J. Zheng, J. H. Davidson, Synthesis gas production via the solar partial oxidation of methane-ceria redox cycle: Conversion, selectivity, and efficiency, International Journal of Hydrogen Energy, (2016).
[37] K. J. Warren, J. R. Scheffe, Kinetic insights into the reduction of ceria facilitated via the partial oxidation of methane, Materials Today Energy, 9 (2018) 39-48.

### Example 2

Ce_{0.9}Zr_{0.1}O₂ was synthesized using a modified Pechini method. Briefly, stoichiometric quantities of ZrO(NO₃)₂.xH₂O (Sigma-Aldrich, 243493) and Ce(NO₃)₃.6H₂O (Sigma-Aldrich, 238538) were dissolved with citric acid in 20 mL of deionized water. Prior to synthesis, the degree of hydration of the zirconium oxynitrate hydrate was determined via thermogravimetric analysis during thermal decomposition at 900° C. The ratio of citric acid to metal cations was 3:2 [1, 2]. After stirring the mixture for 2 hours, ethylene glycol was added at a 2:1 molar ratio to citric acid [3]. The solution was then heated to 90° C. and stirred until a gel was formed. The resulting gel was dried at 300° C. [4] for 3 hours to form a powder. The powder was ground with a mortar and pestle, then was sintered at 1200° C. for 12 hours. Commercial CeO₂ powder (Alfa Aesar, 11328) used herein was sintered under identical conditions prior to experimentation.

The crystalline structure of Ce_{0.9}Zr_{0.1}O₂ was characterized via powder X-ray diffraction (PXRD) using a PANalytical X′Pert Powder Diffractometer with Cu-Kα radiation and 45 kV/40 mA output over 20 from 20-100° with a 0.008° step size at 10.16 seconds per step. Background detection and subtraction was performed using the PANalytical HighScore Plus v. 3.0e software. Scanning electron microscopy (SEM) and energy-dispersive X-ray spectroscopy (EDS) (FEI Nova NanoSEM 430, 15.0 kV, 0.18 nA) were performed to examine the surface morphology and confirm homogeneous distribution of the metal cations. EDS was also used to determine the ratio of Zr to Ce cations in the material. The specific surface areas (SSA) of the commercial and synthesized samples were measured via multi-point Brunauer-Emmett-Teller (BET) analysis (Autosorb iQ) using nitrogen.

A horizontally-oriented thermogravimetric analyzer (HT TGA/DSC 2, Mettler Toledo) was utilized in series with a QMS 100 series gas analyzer (Stanford Research Systems) to quantify the reduction extent and outlet gaseous effluent of methane-driven reduction of Ce_{0.9}Zr_{0.1}O₂ and CeO₂. Methane-driven reduction was initiated at an inlet methane partial pressure (pCH₄) of 0.03 atm in Ar; the total volumetric flowrate (Qₜₒₜ) was 80 mL min⁻¹. For simplicity, O₂ was selected as the oxidant, and oxidation was initiated at an oxygen partial pressure (pO₂) of 0.15 atm in Ar; here, the total volumetric flowrate was 65 mL min⁻¹. Reduction and oxidation regimes were separated by a brief purge in Ar (Qₜₒₜ=80 mL min⁻¹). Reduction was performed to equilibrium, and thus the duration was dependent upon the desired reference temperature (T_{ref}). Oxidation, however, was kept constant at 2 minutes. Reactions were initiated via an electronic mass flow controller (GC200, Mettler Toledo). All flows were standardized at 25° C. and 1 atm, and inlet gases were sufficiently mixed upstream of the sample chamber. The total pressure was maintained at 1 atm during all tests.

First, calcined samples were pretreated with two isothermal cycles at 1100° C. to promote reactive stability, and followed by isothermal mass relaxation tests at 750, 650, and 550° C. Heating or cooling in Ar at 10 to 20° C. min⁻¹ enabled a sufficient purge duration between redox tests. For both experiments, 25 mg of powdered samples were arranged in a monolayer of particles on a platinum plate crucible to ensure uniform heat and mass transfer to the reaction site. To account for buoyancy effects observed in the thermogravimetric data, each experiment was repeated with an empty crucible.

Prior to experimentation, the QMS 100 series gas was calibrated by delivering known quantities of analytical grade gas mixtures (i.e., H₂, CO, and CO₂ diluted in Ar). Undetectable rates of H₂O production were quantified via a molar balance of the consumed methane and produced H₂. Carbon deposition was not observed and thus assumed negligible. Therefore, the consumed methane was simply determined from the sum of other carbonaceous species, CO and CO₂. Equilibrium reduction extents were determined via the thermogravimetric measurement and the summation of toxic products and were found to be in agreement.

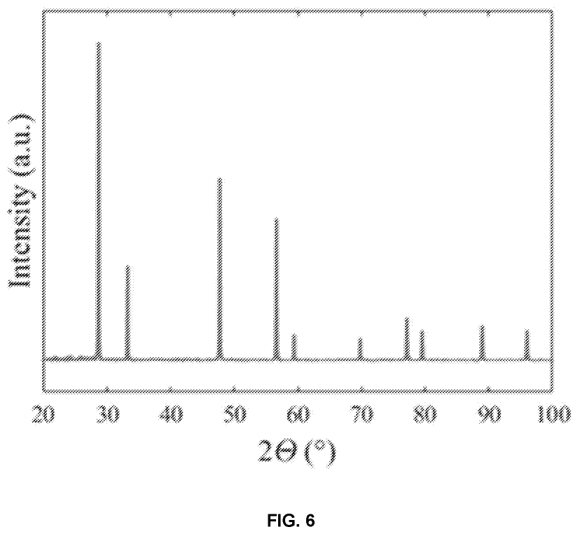

To compliment the equilibrium thermodynamic predictions, as-synthesized Ce_{0.9}Zr_{0.1}O₂ samples were subjected to the first step of the proposed chemical-looping combustion scheme in a thermogravimetric analyzer. In agreement with prior literature [5], the powdered Ce_{0.9}Zr_{0.1}O₂ sample was confirmed to adopt the cubic flourite phase, as can be seen by the PXRD data shown in FIG. 6. The desired Zr composition was further validated by averaging the EDS results over five randomly selected positions, which yielded an actual Zr composition of 10.24 mol %. The measured BET specific surface areas of calcined Ce_{0.9}Zr_{0.1}O₂ and CeO₂ powders were 0.966 m² g⁻¹ and 0.929 m² g⁻¹, respectively.

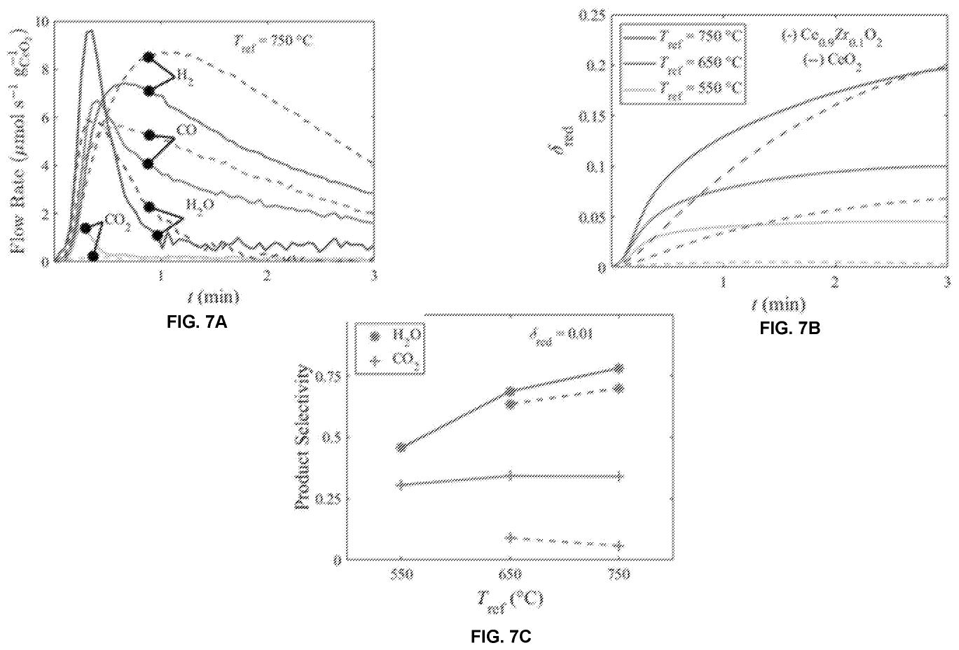

FIGS. 7A-7C display pertinent results from employing multistage isothermal thermogravimetry coupled with downstream residual gas analysis to analyze methane-driven reduction of Ce_{0.9}Zr_{0.1}O₂ and CeO₂. As can be seen in FIG. 7A which shows representative reaction rates of product gases at 750° C., each sample's product effluent is initially characterized by large amounts of H₂O where the amount of surface oxygen is most abundant. Importantly however, CO₂ production is only significant for Ce_{0.9}Zr_{0.1}O₂, trends which were predicted by thermodynamic calculations. For longer reaction times product gases of both samples are dominated by H₂ and CO, confirming that the selective production of syngas proceeds via the oxygen vacancy-mediated dissociation of methane [6]. The concomitant reduction extent, measured via thermogravimetry, is shown in FIG. 7B for T_{ref}=550, 650, and 750° C. at pCH₄=0.03 atm. Reaction rates increased with increasing temperature and were greater for Ce_{0.9}Zr_{0.1}O₂ than CeO₂. In agreement with thermodynamic predictions, for temperatures lower than 750° C., -red was greater for Ce_{0.9}Zr_{0.1}O₂ than CeO₂. However, the magnitudes of the measured reduction extents are different than the thermodynamic predictions because, in open system operation, product gases are swept away, which lower the local pO₂. Most notably, H₂O and CO₂ selectivity, defined with respect to the amount of methane consumed, was greater for methane-driven reduction of Ce_{0.9}Zr_{0.1}O₂ versus CeO₂, as shown in FIG. 7C for constant composition. Selectivity to H₂O and CO₂ increased with increasing temperatures due to faster kinetics. The selectivity could not be defined under the examined conditions for CeO₂ at 550° C., as the reaction did not proceed meaningfully. Importantly, these results demonstrate that higher rates of CO₂ and H₂O are attainable by introducing zirconia into the ceria lattice.

### References for Example 2

[1] J. R. Scheffe, R. Jacot, G. R. Patzke, A. Steinfeld, Synthesis, characterization, and thermochemical redox performance of Hf4+, Zr4+, and Sc3+ doped ceria for splitting CO2, The Journal of Physical Chemistry C, 117 (2013) 24104-24114.
[2] T. Cooper, J. R. Scheffe, M. E. Galvez, R. Jacot, G. Patzke, A. Steinfeld, Lanthanum Manganite Perovskites With Ca/Sr A-Site and Al B-Site Doping as Effective Oxygen Exchange Materials for Solar Thermochemical Fuel Production, Energy Technology, 3 (2015) 1130-1142.
[3] Y.-S. Han, H.-G. Kim, Synthesis of LiMn2O4 by modified Pechini method and characterization as a cathode for rechargeable Li/LiMn2O4 cells, Journal of power sources, 88 (2000) 161-168.
[4] Q.-L. Meng, C.-i. Lee, T. Ishihara, H. Kaneko, Y. Tamaura, Reactivity of CeO2-based ceramics for solar hydrogen production via a two-step water-splitting cycle with concentrated solar energy, international journal of hydrogen energy, 36 (2011) 13435-13441.
[5] Y. Hao, C.-K. Yang, S. M. Haile, Ceria-Zirconia Solid Solutions (Ce1−xZrxO2−δ, x≤0.2) for Solar Thermochemical Water Splitting: A Thermodynamic Study, Chemistry of Materials, 26 (2014) 6073-6082.
[6] K. J. Warren, J. R. Scheffe, The Role of Surface Oxygen Vacancy Concentration on the Dissociation of Methane over Nonstoichiometric Ceria, The Journal of Physical Chemistry C, (2019).

### Example 3

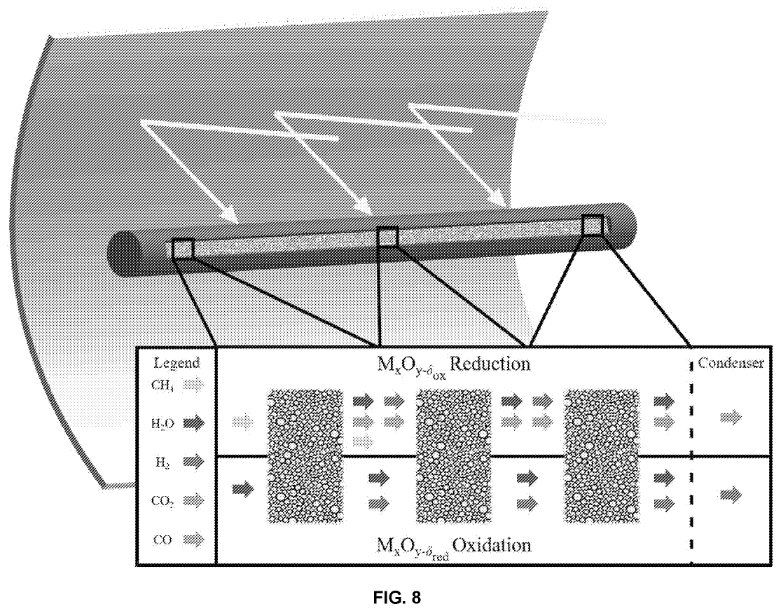

As noted in the prior equilibrium thermodynamic analysis, complete selectivity to H₂O and CO₂ during methane-driven reduction will require the exposure of undesired reforming products (i.e., CH₄, H₂, and CO) to the unreacted metal oxide. In practice, delivering a less than stoichiometric ratio of CH₄ to metal oxide to coerce further product oxidation can be easily accomplished in a packed-bed reactor, as shown in the schematic presented in FIG. 8. By tailoring the input CH₄ relative to the bed length and leveraging condensation, pure streams of CO₂ can be produced-without inducing any energy penalty from gas separation- and later sequestered in various geological media to mitigate anthropogenic effects on climate change. Conversely, during oxidation, pure streams of H₂ and/or CO can be produced by delivering each oxidant separately or in unison [1]. For CO₂ splitting, at the expense of lower oxidant extents, gas separation can be avoided by delivering less than stoichiometric ratios of CO₂ to metal oxide to produce pure CO. Otherwise, condensation is again leveraged to enable facile gas separation for H₂O splitting. Here, carbon neutral utilization of methane is permitted if a renewable energy resource is implemented to drive the desired reactions. Furthermore, process thermodynamics enable low-temperature operation (T≈550° C.), such that, in the case of concentrating solar as shown in FIG. 8, comparatively-inexpensive systems like parabolic troughs may be employed. Although parabolic troughs are not well suited for driving typical reforming and partial oxidation reactions (e.g., commercial SMR and POM occur at T>800° C. [2]), operating temperatures exceeding 600° C. have been demonstrated using air as a heat transfer fluid [3], which is sufficient for facilitating the proposed CLC scheme.

### References for Example 3

[1] P. Furler, J. R. Scheffe, A. Steinfeld, Syngas production by simultaneous splitting of H₂O and CO2 via ceria redox reactions in a high-temperature solar reactor, Energy & Environmental Science, 5 (2012) 6098-6103.
[2] D. A. Wood, C. Nwaoha, B. F. Towler, Gas-to-liquids (GTL): A review of an industry offering several routes for monetizing natural gas, Journal of Natural Gas Science and Engineering, 9 (2012) 196-208.
[3] P. Good, G. Ambrosetti, A. Pedretti, A. Steinfeld, An array of coiled absorber tubes for solar trough concentrators operating with air at 600° C. and above, Solar Energy, 111 (2015) 378-395.

Ratios, concentrations, amounts, and other numerical data may be expressed in a range format. It is to be understood that such a range format is used for convenience and brevity, and should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1% to about 5%, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, the term “about” can include traditional rounding according to significant figure of the numerical value. In addition, the phrase “about ‘x’ to ‘y’” includes “about ‘x’ to about ‘y’”.

Unless defined otherwise, all technical and scientific terms used have the same meaning as commonly understood by one of ordinary skill in the art to which this disclosure belongs. Although any methods and materials similar or equivalent to those described can also be used in the practice or testing of the present disclosure, the preferred methods and materials are now described.

Embodiments of the present disclosure will employ, unless otherwise indicated, techniques of separating, testing, and constructing materials, which are within the skill of the art. Such techniques are explained fully in the literature.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

1. A method of reforming a hydrocarbon, comprising:
exposing the hydrocarbon to an oxide, and
forming, primarily, H₂O and CO₂ or H₂O and C as opposed to formation of H₂ and CO.

2. The method of claim 1, wherein the hydrocarbon is methane, wherein exposing is conducted under operating conditions that are selected to form H₂O and CO2 or H₂O and C as opposed to the formation of H₂ and CO.

3. The method of claim 2, wherein the operating conditions comprise operation at a temperature of less than 1000° C.

4. The method of claim 2, wherein the operating conditions comprise operation at a temperature of less than 800° C.

5. The method of claim 2, wherein the operating conditions comprising operation at a temperature of about 700-800° C.

6. The method of claim 2, wherein exposing is conducted for about 1 second to 1 hour to form H₂O and either CO₂ or C over H₂ and CO.

7. The method of claim 1, wherein the oxide is selected from an oxide having a characteristic of forming H₂O and either CO₂ or C over H₂ and CO.

8. The method of claim 2, wherein the oxide having a characteristic of forming H₂O and either CO₂ or C over H₂ and CO is selected from the group consisting of: an oxide of zinc, tin, iron, cobalt, copper, alumina, cerium, and mixtures thereof, wherein the oxide is optionally doped with one or more of: strontium, lithium, gadolinium, samarium, praseodymium, zirconia, or hafnium.

9. The method of claim 8, wherein the oxide is cerium doped with zirconia.

10. The method of claim 2, wherein an energy to generate a temperature operating condition is provided by a parabolic trough.

11. The method of claim 1, wherein the forming forming comprises about less than 5% H₂ and CO.

12. The method of claim 1, wherein the forming comprises forming about less than 1% H₂ and CO.

13. A system for reforming a hydrocarbon, comprising
a reforming reactor, wherein the reforming reactor is configured to operate at operating conditions to primarily form H₂O and CO₂ or H₂O and C as opposed to formation of H₂ and CO; and
a parabolic trough, wherein the parabolic trough is in electrical or thermal communication with the reforming reactor, wherein energy derived from the parabolic trough is used to adjust the operating conditions in the reforming reactor.

14. The system of claim 13, wherein the operating condition comprises operation at a temperature of less than 1000° C.

15. The system of claim 13, wherein the operating condition comprises operation at a temperature of about 700° C. to 800° C.

16. The system of claim 13, wherein the reforming reactor is configured to primarily form H₂O and CO₂ or H₂O and C from methane as opposed to the formation of H₂ and CO.

17. The system of claim 13, wherein the system is configured to primarily form H₂O and CO₂ or H₂O and C and configured to form about less than 5% H₂ and CO.

18. The system of claim 13, wherein the system is configured to primarily form H₂O and CO₂ or H₂O and C and configured to form about less than 1% H₂ and CO.

19. The system of claim 13, wherein the reforming reactor comprises an oxide having a characteristic of primarily forming H₂O and either CO₂ or C over H₂ and CO, wherein the oxide is selected from the group consisting of: an oxide of zinc, tin, iron, cobalt, copper, alumina, cerium, and mixtures thereof, wherein the oxide is optionally doped with one or more of: strontium, lithium, gadolinium, samarium, praseodymium, zirconia, or hafnium.
